(19) United States
(12) Patent Application Publication
(10) Pub. No.: US 2011/0278524 A1
(43) Pub. Date: Nov. 17, 2011

(54) LIFT ASSEMBLY FOR MANAGING ROD HOLDERS ON FISHING BOATS

(76) Inventor: Hector Paredes, Miami, FL (US)

(21) Appl. No.: 12/778,583

(22) Filed: May 12, 2010

(51) Int. Cl. A01K 97/10; B63B 17/00; B66F 11/00; B66F 3/00; B66F 3/24

(52) U.S. Cl. 254/93 R; 254/120

(57) ABSTRACT

The invention is directed to a lift assembly for lowering and elevating rod holders on a fishing boat. The lift assembly includes first and second horizontal positioning beams parallel to one another. Affixed to the positioning beams are a first pivoting assembly and second pivoting assembly. The first pivoting assembly has a stationary vertical beam having a first and second end (attached to both horizontal positioning beams). A first pivoting beam attaches via a first hinge to the first end of the vertical stationary beam, while a second pivoting beam attached to the second end of the vertical stationary beam via a second hinge. The first pivoting assembly includes a second vertical beam that attaches to both distal ends of the first pivoting beam and the second pivoting beam. The lift assembly may include a power train (a hydraulic position) to lower and elevate the first and second pivoting assembly.

### FIELD OF THE INVENTION

The invention relates to a lift assembly designed to manage rod holders on fishing boats. Moreover, the invention relates to a system of retrieving and positioning various rod holders on fishing boats through use of a lift assembly.

### BACKGROUND OF THE INVENTION

Offshore boat fishing, also called deep sea or open water fishing, represents a popular recreational sport in the United States. Offshore boat fishing typically includes fishing in water more than 30 meters deep at some distance from land. Specialized knowledge is needed regarding weather patterns, navigation and safety precautions. Accordingly, most offshore boat fishing is conducted by either more experienced recreational fishermen or through charters with professional guides.

Offshore boats are generally larger than inshore boats and are designed to have sturdy construction to sustain water conditions in open waters. They are also typically more difficult to build and maintain. Accordingly, offshore boat fishing is often a pastime of the affluent and/or caters to vacationers that desire a unique luxurious experience. In addition, the fish typically caught in offshore boat fishing are often more desirable, including marlin and tuna.

Because fish typically caught in offshore boat fishing can be large, heavy tackle and specialized sea rods (also known as downtide rods) must be used. These sea rods include a pole and a reel attached to the poll through a fastener. Positioned at the distal end of each pole is a handle—which is typically soft, pliable and contains a suitable gripping surface.

One popular technique used in offshore boat fishing to maximize the chance of catching larger more desirable fish is trolling. Trolling first includes the positioning of a plurality of sea rods in parallel relation to one another. This position occurs by placing the handle of each sea rod within an rod holder. Each rod holder includes a tubular casing of a sufficient size and dimension to maintain and secure each sea rod. By positioning multiple rod holders on the boat, the plurality of sea rods can be secured without need for manual use—while the boat proceeds into deep water to catch fish.

Typically, rod holders are positioned on the roofs and balconies of larger offshore boats to maximize the number of sea rods to be used while fishing. Such devices are often positioned in a high enough place to avoid risking fisherman hitting their heads on the various rod holders. However, this often makes it difficult to both position and retrieve the sea rods from the rod holders. Quick and safe retrieval of the sea rods is of paramount importance in order to position the pole onto the fisherman to reel in a hooked fish.

Accordingly, there is a need in the field of offshore boat fishing for a device that allows quick, safe and reliable positioning and retrieval of sea rods that are difficult to remove from out of reach rod holder. Moreover, there is a need in the art of deep sea fishing for an effective method of retrieving a sea rod when it appears that the sea rod has engaged a sport fish.

### SUMMARY OF THE INVENTION

The invention relates to a lift assembly capable of lowering and elevating one or more rod holders in relation to a deep sea fishing boat. In one embodiment, the lift assembly may include a first horizontal positioning beam and second horizontal positioning beam. Both positioning beams are parallel to one another and function to affix both a first pivot assembly and second pivot assembly to the fishing boat.

The first pivoting assembly has a stationary vertical beam having a first end and a second end (attached to both horizontal positioning beams). A first pivoting beam attaches via a first hinge to the first end of the vertical stationary beam, while a second pivoting beam attached to the second end of the vertical stationary beam via a second hinge. The first pivoting assembly also includes a second vertical beam that attaches to both distal ends of the first pivoting beam and the second pivoting beam.

The second pivoting assembly includes the same components, functionality, size and dimensions as the first pivoting assembly. Dispersed between both the first and second pivoting assembly is a horizontal positioning beam capable of positioning one or more rod holders. This horizontal positioning beam attaches to the second pivoting beam of both the first pivoting assembly and the second pivoting assembly.

Optionally, the first pivoting assembly may include both a third hinge and a fourth hinge to help lower and raise the horizontal positioning beam. More specifically, the first pivoting beam of the first vertical assembly may be attached to the second vertical beam through a third hinge. Further, the second pivoting beam of the first vertical assembly may be attached to the second vertical beam through a fourth hinge. Optionally, the fourth hinge functions to slide along the second pivoting beam.

The lift assembly may also employ a power train to lower and elevate both the first pivoting assembly and the second pivoting assembly. One of many power trains contemplated by the invention is a hydraulic piston that includes a first fastener, a piston, a movable shaft, and a second fastener. Here, the first fastener attaches to the vertical positioning beam while the second fastener attaches to the second pivoting beam.

The invention further contemplates a second embodiment for the lift assembly. In the second embodiment, the lift assembly includes a first pivoting assembly having a first pivoting beam and a second pivoting beam. The first pivoting beam has a first end and a second end wherein the first end is connected to the fishing boat through a first hinge. The second end of the first pivoting beam connected (via a second hinge) to a second pivoting beam. Both the first hinge and second hinge may be spring loaded. The second pivoting assembly mirrors the functionality, structure, size and dimension of the first pivoting assembly. Both pivoting assemblies can include a power train, such as a hydraulic piston. Dispersed between (and perpendicular to) both pivoting assemblies is a horizontal positioning beam capable of maintaining one or more rod holders.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 illustrates the components of a traditional fishing rod for use in offshore boat fishing;

FIG. 2 illustrates the typical placement and positioning of rod holders on a fishing boat;

FIG. 3 is a perspective view of the lift assembly that includes a plurality of rod holders;

FIG. 4 is a front view of the lift assembly showing one positioning on an off-shore fishing boat;

FIG. 5 is a side view showing the lift assembly;

FIG. 6 is a side view showing the lift assembly having a motorized pulley system as a power train;

FIG. 7 illustrates the lift assembly where the power train is a hydraulic piston;

FIG. 8 is a side view of a second embodiment of the lift assembly; and

FIG. 9 shows the how the second embodiment of the lift assembly can include a hydraulic piston as a power train.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Components of Both Sea Rods and Rod Holders

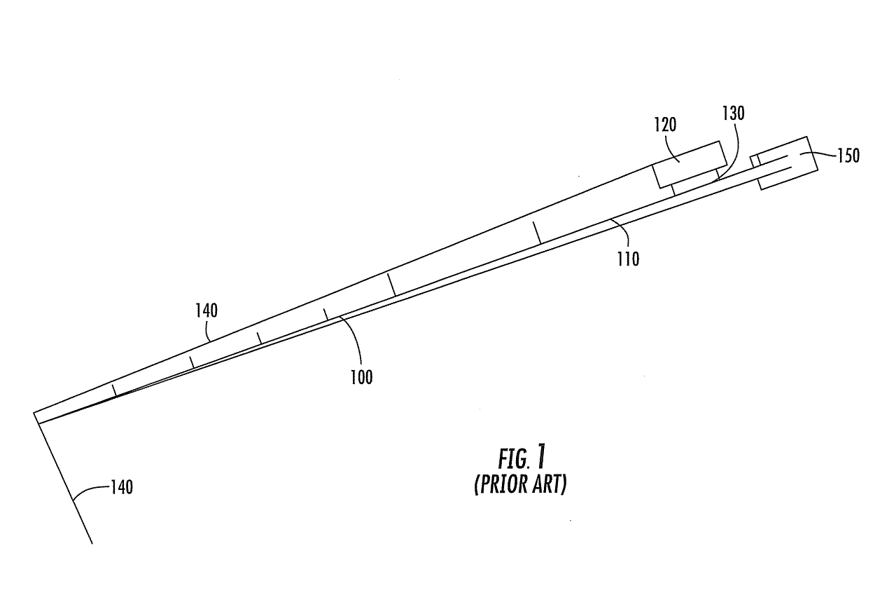

FIG. 1 provides, by way of example, the common components of a fishing rod 100 often used for offshore boat fishing. The fishing rod 100 may include, but is certainly not limited to, a pole 110, a reel 120, a connector 130, tackle 140 and a handle 150. The fishing rod 100 contemplated for use by the invention can be a trolling rod, deep sea fishing rod or any type of rod known and used by those in the art. As illustrated in FIG. 1, the reel 120 is rigidly connected to the pole 110 through a connector 130. Moreover, tackle 140 is drawn from the reel 120 and directed through various threads positioned along the pole 110. The tackle 140 is usually high strength composite capable of returning a large fish such as a tuna, dolphin or swordfish. The handle 150 is located at the distal end of the pole 110 for use by a fisherman.

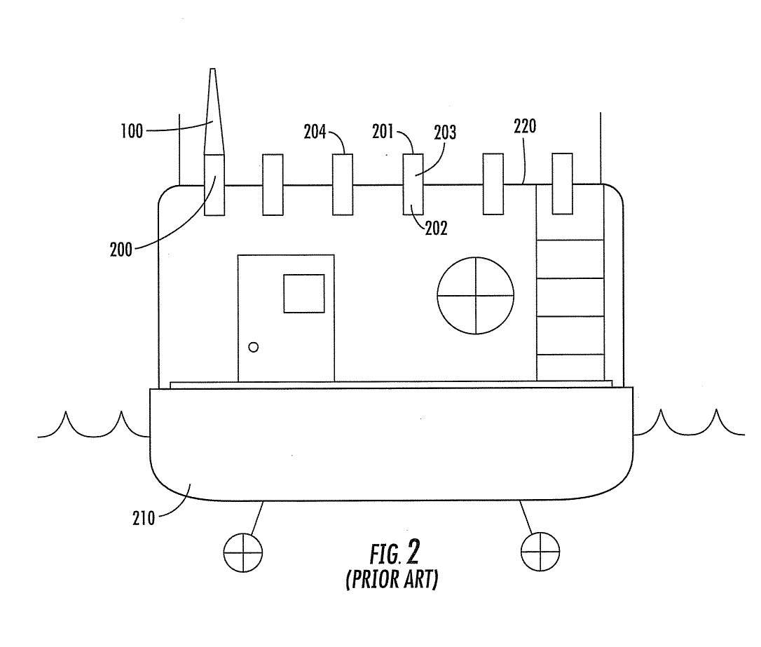

While FIG. 1 illustrates the main components of a fishing rod 100, FIG. 2 shows the proper positioning, location and structure of a fishing rod 200. As shown, rod holders 200 are typically positioned in a high portion of an offshore fishing boat 210. The rod holders 200 are often placed on a balcony wall 220 positioned above the main floor and walking area of the fishing boat 210. Moreover such rod holders 200 can be placed, positioned and affixed throughout the back and sides of a conventional fishing boat 210.

Most rod holders 200 are cylindrical in shape having a top side 201, a corresponding bottom side 202 and a sheath 203. Positioned at the top side 201 of the rod holder 200 is an opening 204. Both the opening 204 and sheath 203 have a sufficient size and dimension to maintain and secure the handle 150 of fishing rod 100 (shown in FIG. 1). The rod holder 200 is typically made of a hard, resilient and rustproof material such as PVC, aluminum, stainless steel, or other polymer material.

### First Embodiment of the Lift Assembly

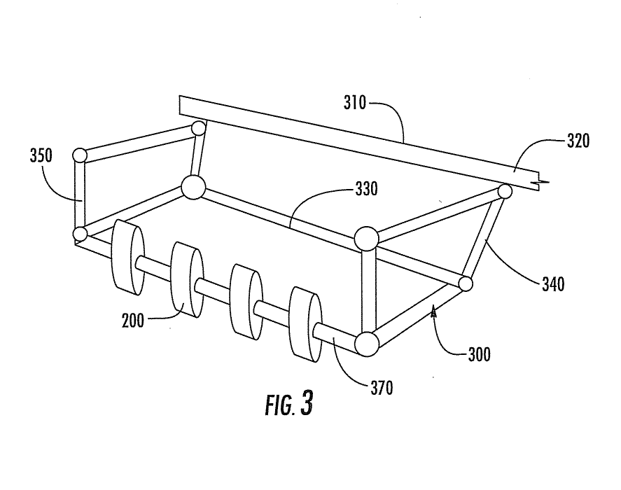

FIGS. 3 through 6 illustrate, by way of example, one preferred embodiment of a lift assembly 300. First turning to FIG. 3, the lift assembly 300 includes, but is certainly not limited to, a set of horizontal attachment beams 310, a first pivoting assembly 340, a second pivoting assembly 350 (in parallel to the first pivoting assembly 340), and at least one horizontal positioning beam 370. Positioned on the horizontal positioning beam 370 is at least one rod holder 200.

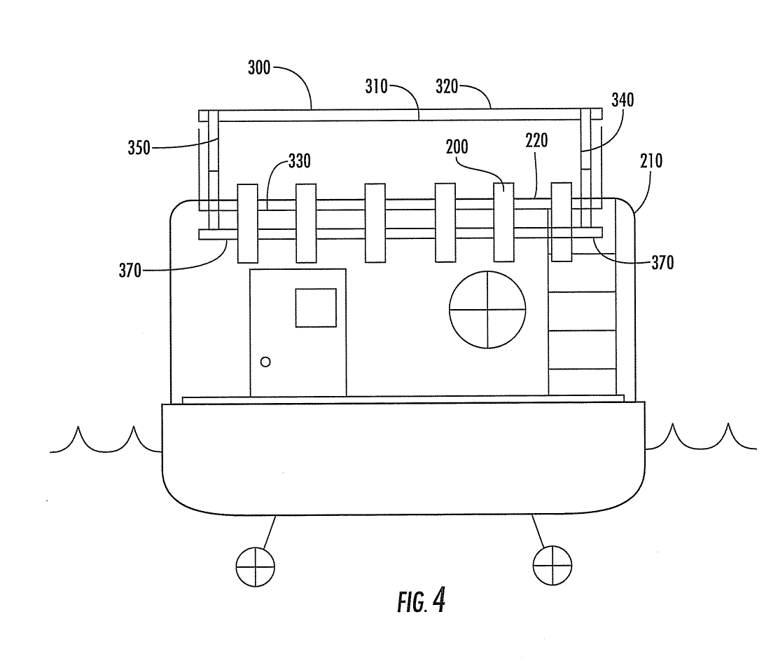

As further shown in FIG. 3, the lift assembly 300 includes a first attachment beam 320 and a corresponding second attachment beam 330. Both attachment beams 320 and 330 are essentially in parallel relation to one another. Moreover, the set of horizontal attachment beams 310 are affixed directly to the offshore fishing boat 210 (shown and illustrated in FIG. 4). These attachment beams 310 can be made and manufactured out of wood, metal, plastic (including but not limited to PVC), composite or any non-corrosive and study material known to those of ordinary skill in the art.

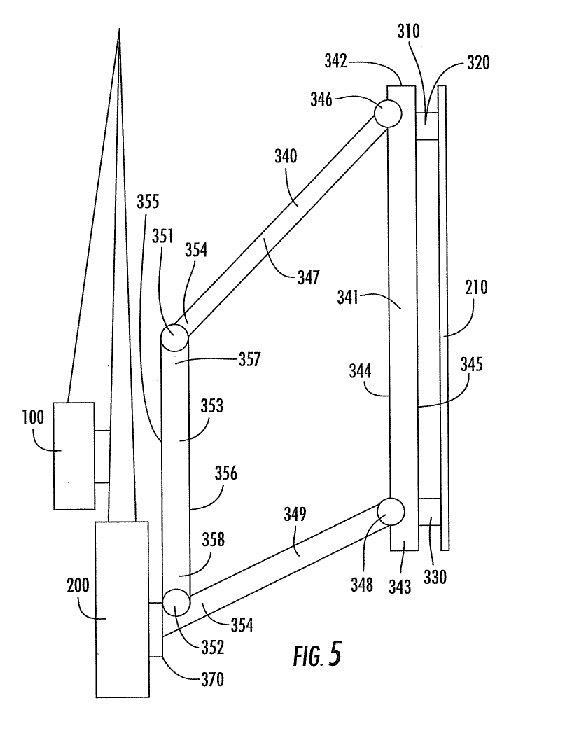

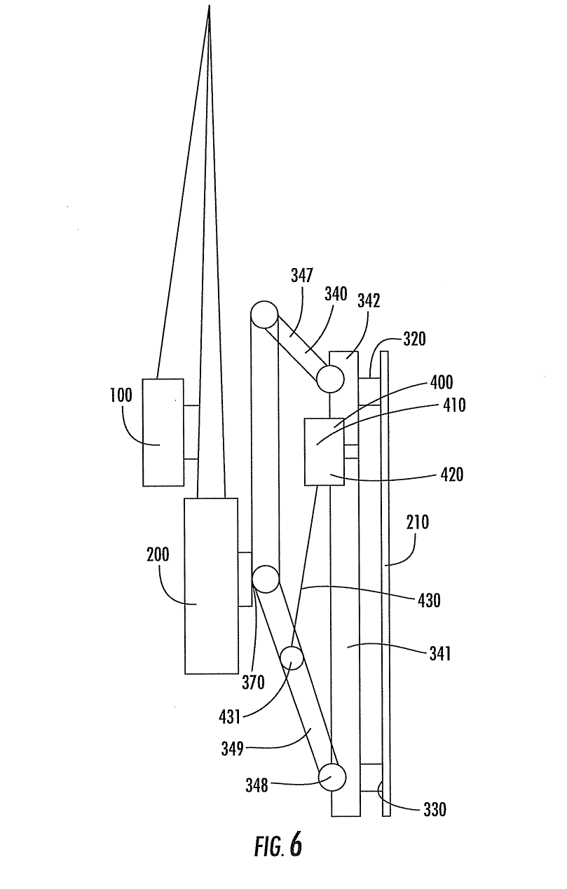

Both FIG. 5 and FIG. 6 show one preferred construction of the first pivoting assembly 340. Comparison of both figures provides the primary functionality of the first pivoting assembly 340 (as well as the second pivoting assembly 350 described in greater detail below). Specifically, each pivoting assembly (340 or 350) vertically lower or elevate the horizontal positioning beam 370—which in turn helps position one or more fishing rods 100 into one or more rod holders 200.

First turning to FIG. 5, the first pivoting assembly 340 includes a stationary vertical beam 341. This stationary vertical beam 341 has a top end 342, a corresponding bottom end 343, a first surface 344 and a corresponding second surface 345. The set of horizontal attachment beams 310 attaches to the second surface 345 of the stationary vertical beam 341. More specifically, the first horizontal attachment beam 320 attaches proximate to the top end 342, while the second horizontal attachment beam 330 attaches proximate to the bottom end 343 of the stationary vertical beam 341.

Further shown in FIG. 5, positioned on the first surface 344 near the top end 342 is a first pivoting hinge 346. The first pivoting hinge 346 is attached to a first pivoting beam 347. Likewise, positioned on the first surface 344 near the bottom end 343 is a second pivoting hinge 348. This second pivoting hinge 348 connects to a second pivoting beam 349. As described in greater detail below, both hinges 346 and 348 can be equipped with a motor, a pulley system, hydraulics or any electro-mechanical system known to those of ordinary skill in the art—to aide in vertically positioning both the first pivoting beam 347 and the second pivoting beam 349.

Both FIG. 3 and FIG. 5 show how both pivoting beams 347 and 348 are equipped with additional third and fourth pivoting hinges 351 and 352 in order to affix a second vertical beam 353. The second vertical beam 353 has a first surface 355, a corresponding second surface 356, a first end 357 and a corresponding second end 358. This second vertical beam 353 helps stabilize the first pivoting assembly 340. In turn, this helps create a rigid surface in order to position, lift, and lower the various rod holders 200.

As further shown in FIG. 5, both pivoting beams 347 and 348 have a distal end 354. Positioned at the distal end 354 of the first pivoting beam 347 is the third pivoting hinge 351. Likewise, the fourth pivoting hinge 352 is positioned at the distal end 354 of the second pivoting beam 349. Both pivoting hinges 351 and 352 connect to the second surface 356 of the second vertical beam 353. As shown in FIG. 5, the third pivoting hinge 351 connects at the first end 357 of the second vertical beam 353. Correspondingly, the fourth hinge 352 attaches to the second end 358 located on the second surface 356 of the second vertical beam 353.

Positioning and attachment of both pivoting hinges 351 and 352 allow the second vertical beam 353 to remain essentially parallel to the stationary vertical beam 341 throughout use of the vertical assembly 300. Accordingly, both pivoting beams 347 and 349 along with the second vertical beam 353 work together to vertically elevate or lower the plurality of rod holders 200.

One optional feature of either the pivoting hinges 351 and 352 is the ability to slide along the pivoting beams 347 and 348. For example, to ensure the second vertical beam 353 is maintained in an essentially vertical position throughout its lowering and elevation, the fourth pivoting hinge 352 may slide about the second pivoting beam 349.

Still another additional functionality of the first pivoting assembly 340 is including a power train 400 sufficient to lower and elevate the rod holders 200 without physical exertion by the user. One manner of creating an effective power train 400 is through use of a motorized pulley system 410 shown in FIG. 6. As illustrated, a motor 420 is positioned and affixed near the top end 342 of the stationary vertical beam 341. Attached to the motor 420 is a tension cable 430. The distal end 431 of the tension cable 430 to the middle portion of the second pivoting beam 349.

An alternative arrangement of the motorized pulley system 410 is also contemplated by the invention. Under this alternative position, the motor 420 is affixed to the middle portion of the second pivoting beam 349. Here, the distal end 431 of the tension cable 430 is affixed proximate to the top end 342 of the stationary vertical beam 341. Other arrangements of the motorized pulley system 410 will be recognized and understood by those of ordinary skill in the art upon review of the foregoing disclosure and FIGS. 5 through 6.

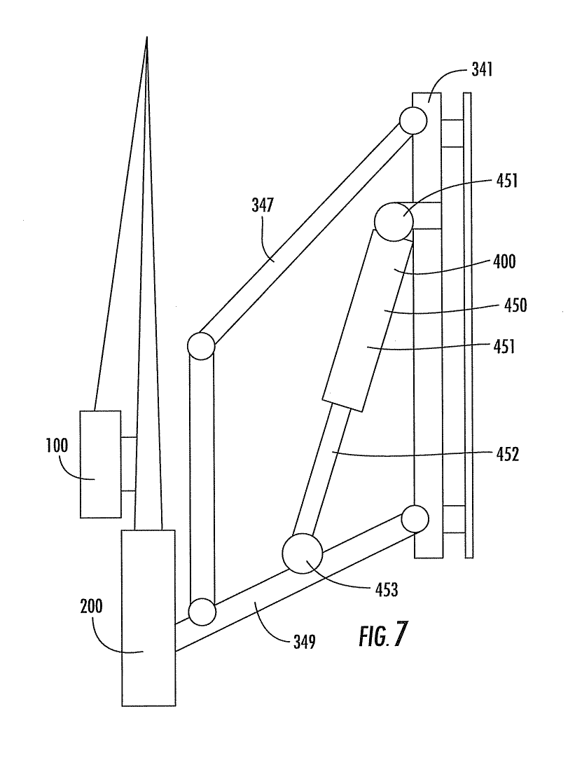

A second contemplated power train 400 includes the hydraulic piston 450 shown and illustrated in FIG. 7. Similar to the overall positioning and function of the motorized pulley system 410 shown in FIG. 6, the hydraulic piston 450 shown in FIG. 7 includes a first fastener 451, a piston 451 (attached to the first fastener 451), a movable shaft 452 and a second fastener 453. As shown, the second fastener 453 attaches to the middle portion of the second pivoting beam 349. Here, the movable shaft 452 withdraws from the piston 451 in order to lower the second pivoting beam 349. Alternatively, the piston 451 can retrieve the movable shaft 452 causing the second pivot beam 349 to lift upwards—such that the various rod holders 200 become elevated away from the fisherman.

Turning back to FIG. 3, it is important to note that the structure, functionality and construction of the second pivoting assembly 350 mirrors that of the first pivoting assembly 340. As illustrated in FIG. 3, the second pivoting assembly 350 attaches to the corresponding ends of both the first attachment beam 320 and a corresponding second attachment beam 330. Attached to both beams is another stationary vertical beam 341 having a top end 342, a bottom end 343, a first surface 344 and a corresponding second surface 345.

As further illustrated in FIG. 3, the second pivoting assembly 350 further includes a first pivoting hinge 346 positioned proximate the top end 342 of stationary vertical beam 341, while a second pivoting hinge 348 is positioned near the second end 343. A first pivoting beam 347 attaches to the first pivoting hinge 346, while a second pivoting beam 349 attaches to the second pivoting hinge 349. The distal ends 354 of both pivoting beams 347 and 349 of the second pivoting assembly 350 attach to a second vertical beam 353. More specifically, the distal end 354 of the first pivoting beam 347 attaches through a third pivoting hinge 351, while a fourth pivoting hinge 352 is positioned at the distal end 354 of the second pivoting beam 349.

As further illustrated in FIG. 3, both the first pivoting assembly 340 and the second pivoting assembly 350 include a separate second vertical beam 353. Attaching at the bottom end 343 of first surface 344 of second vertical beams 353 is a horizontal positioning beam 370. This horizontal positioning beam 370 provides a sufficient span to position and affix one or more rod holders 200.

Optionally, an additional horizontal positioning beam 370 may be affixed to the top end 342 of the top surface 344 of both second vertical beams 353. This can allow additional rod holders 200 to be positioned and affixed.

### Second Embodiment of the Lift Assembly

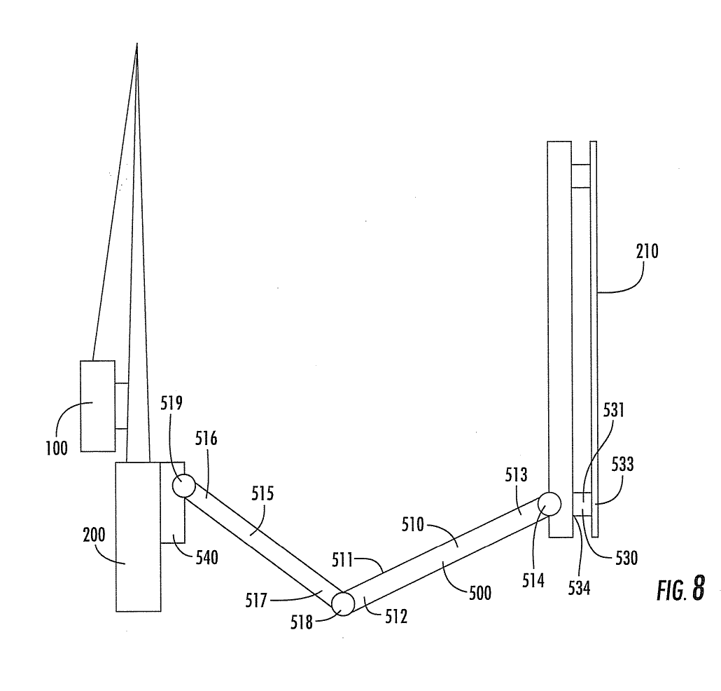

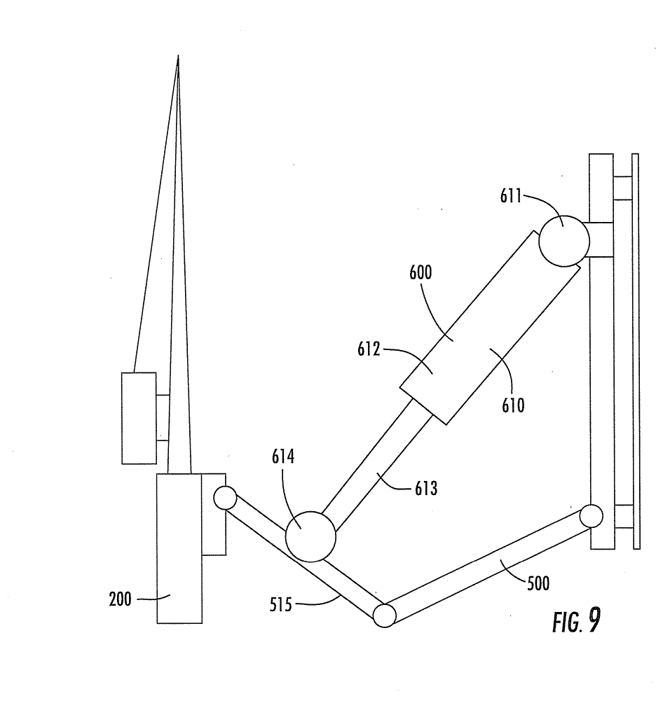

The invention also contemplates a second embodiment of the lift assembly 500 illustrated in FIG. 8 and FIG. 9. First turning to FIG. 8, the lift assembly 500 includes, but is certainly not limited to three primary components: a first pivoting assembly 510, a second pivoting assembly 520 (in parallel relation to the first pivoting assembly 510), a horizontal attachment beam 530 and a horizontal positioning beam 540 (which attaches to the distal ends of both the first pivoting assembly 510 and the second pivoting assembly 520). The horizontal positioning beam 540 is capable of positioning and maintaining one or more rod holders 200.

The horizontal attaching beam 530 includes a first end 531, a corresponding second end 532 (not shown), a first side 533 and a corresponding second side 534. The first pivoting assembly 510 attaches to first end 531 of the horizontal attaching beam 530, while the second pivoting assembly 520 attaches to the second end 532. The boat 210 attaches to the first side 533 of the horizontal attaching beam 530.

FIG. 8 further illustrates, by way of example, one embodiment of the first pivoting assembly 510. As shown, the first pivoting assembly 510 includes a first pivoting beam 511, and a second pivoting beam 515. The first pivoting beam 511 has a first end 512 and a corresponding second end 513. Affixed to this second end 513 is a first hinge 514. The first hinge 514 (which can be spring loaded) attaches to the second side 534 of the horizontal attaching beam 530.

As is further shown in FIG. 8, the second pivoting beam 515 includes a first end 516 and a corresponding second end 517. A second hinge 518 (which can also be spring loaded) is positioned at the second end 517 of the second pivoting beam 515. This second hinge 518 helps connect the second pivoting beam 515 to the first end 512 of the first positioning beam 511. Correspondingly, the horizontal positioning beam 540 can be attached to the first end 516 of the second pivoting beam 515. Optionally, a third hinge 519 or pivot can be placed between the horizontal position beam 540 and the second pivoting beam 515 so that the horizontal positioning beam 540 maintains the rod holder 200 in an essentially vertical position.

While not shown, the second pivoting assembly 520 has the same functionality, structure and dimensions as the first pivoting assembly 510. Moreover, the second pivoting assembly 520 is essentially parallel to the first pivoting assembly 520. Disposed (and perpendicularly positioned) between both pivoting assemblies 510 and 520 is the horizontal positioning beam 540 which provides a sufficient surface area to affix one or more rod holders 200.

The second embodiment of the lift assembly 500 can include a power train 600. The power train 600 can include, but is certainly not limited to, a motorized pulley system, a plurality of spring loaded hinges 514 and 518 (described above and illustrated in FIG. 8), or hydraulic piston 610. Moreover, the power train 600 can incorporate use of gas springs, a plurality of gears in combination with motors. Regardless of type or orientation, the power train 600 functions to lower and elevate both the first pivot assembly 510 and the second pivot assembly 520.

FIG. 9 illustrates when the power train 600 is a hydraulic piston 610. As shown, the hydraulic piston 610 includes a first fastener 611, a piston 612, a movable shaft 613, and a second fastener 614. The first fastener 611 attaches proximate to the first hinge 514 of the first pivoting assembly 510 while the second fastener 614 attaches to the middle portion of the second pivoting beam 515.

I claim:

1. A lift assembly for lowering and elevating one or more rod holders on a boat, the lift assembly comprising:
a first pivoting assembly having a stationary vertical beam having a first end and a second end, a first pivoting beam attaches through a first hinge to the first end of the vertical stationary beam, a second pivoting beam attached to the vertical stationary beam via a second hinge, and a second vertical beam which attaches to both distal ends of the first pivoting beam and the second pivoting beam; and
a horizontal positioning beam attached to the second vertical beam of the first pivoting assembly, the horizontal positioning beam capable of positioning one or more rod holders.

2. The lift assembly of claim 1, further comprising:
a second pivoting assembly essentially parallel to the first pivoting assembly, the second pivoting assembly likewise having a stationary vertical beam having a first end and a second end, a first pivoting beam attaches through a first hinge to the first end of the vertical stationary beam, a second pivoting beam attaches to the vertical stationary beam via a second hinge, and a second vertical beam which attaches to both distal ends of the first pivoting beam and the second pivoting beam, the horizontal positioning beam further attached to the second vertical beam of the second pivoting assembly.

3. The lift assembly of claim 1, further comprising:
a first attachment beam affixed to the first pivoting assembly proximate to the first end of the vertical positioning beam.

4. The lift assembly of claim 2, wherein:
the first attachment beam is affixed to the second pivoting assembly proximate to the first end of the vertical positioning beam.

5. The lift assembly of claim 3, further comprising:
a second attachment beam affixed to the first pivoting assembly proximate to the second end of the vertical positioning beam.

6. The lift assembly of claim 4, wherein:
a second attachment beam is affixed to the second pivoting assembly proximate to the second end of the vertical positioning beam.

7. The lift assembly of claim 1, wherein:
the first pivoting beam of the first vertical assembly is attached to the second vertical beam through a third hinge.

8. The lift assembly of claim 1, wherein:
the second pivoting beam of the first vertical assembly is attached to the second vertical beam through a fourth hinge.

9. The lift assembly of claim 8, wherein:
the fourth hinge functions to slide along the second pivoting beam.

10. The lift assembly of claim 1, further comprising:
a power train capable of lowering and elevating the first pivoting assembly.

11. The lift assembly of claim 10, wherein:
the power train is a hydraulic piston which includes a first fastener, a piston, a movable shaft, and a second fastener, the first fastener attaches to the vertical positioning beam while the second fastener attaches to the second pivoting beam.

12. A lift assembly for lowering and elevating one or more rod holders on a boat, the lift assembly comprising:
a first pivoting assembly having a first pivoting beam and a second pivoting beam, the first pivoting beam having a first end and a corresponding second end wherein the first end is connected to a boat through a first hinge, and a second pivoting beam having a first end and a corresponding second end wherein the first end is connected to the first pivoting beam through a second hinge; and
a second pivoting assembly having a first pivoting beam and a second pivoting beam, the first pivoting beam having a first end and a corresponding second end wherein the first end is connected to the boat through a first hinge, and a second pivoting beam having a first end and a corresponding second end wherein the first end is connected to the first pivoting beam through a second hinge; and
a horizontal positioning beam attached to both the first pivoting assembly and the second pivoting assembly, the horizontal positioning beam capable of positioning one or more rod holders.

13. The lift assembly of claim 12, further comprising a horizontal attachment beam having a first end, a second end, a first side and a second side, wherein the second side attaches to the boat, and wherein the first hinge of the first pivoting assembly attaches to the first side of the horizontal attachment beam at the first end.

14. The lift assembly of claim 12, further comprising a horizontal attachment beam having a first end, a second end, a first side and a second side, wherein the second side attaches to the boat, and wherein the first hinge of the second pivoting assembly attaches to the first side of the horizontal attachment beam and the second end.

15. The lift assembly of claim 11, wherein both the first hinge and the second hinge of the first pivoting assembly are spring loaded.

16. The lift assembly of claim 11, further comprising:
a power train capable of lowering and elevating the first pivoting assembly.

17. The lift assembly of claim 16, wherein:
the power train is a hydraulic piston which includes a first fastener, a piston, a movable shaft, and a second fastener, the first fastener attaches proximate to the first hinge of the first pivoting assembly while the second fastener attaches to the second pivoting beam.
